(19) United States
(12) Patent Application Publication
(10) Pub. No.: US 2022/0398917 A1
(43) Pub. Date: Dec. 15, 2022

(54) System for the spatially limited activation of a control unit

(71) Applicant: Ars Electronica Linz GmbH & Co KG, Linz (AT)

(72) Inventors: Manuel DOBUSCH, Traun (AT); Simon SCHMID, Linz (AT)

(21) Appl. No.: 17/805,195

(22) Filed: Jun. 2, 2022

(30) Foreign Application Priority Data
Jun. 10, 2021 (AT) GM 50122/2021

(51) Int. Cl. G08C 17/02; H04W 4/80; H04W 4/02

(52) U.S. Cl. CPC G08C 17/02; H04W 4/80; H04W 4/023; G08C 2201/91

(57) ABSTRACT

A system for the spatially limited activation of a control unit, comprising an activation unit and a user unit operable to transmit the control signal directly or indirectly to the activation unit, the system further including a relay unit operable to communicate with the user unit and with the activation unit, and the relay unit and/or the user unit are operable to determine, from a signal of the activation unit received from the relay unit, as to whether the relay unit and the activation unit are located within a predetermined spatial area relative to one another, the user unit being operable to transmit the control signal to activate the control unit to the activation unit only if the relay unit and the activation unit are located within the predetermined spatial area relative to one another.

The invention relates to a system for the spatially limited activation of a control unit, comprising an activation unit which is electromechanically or electrically connected to the control unit and is designed for activating the control unit after receiving a control signal, and a user unit designed for transmitting the control signal directly or indirectly to the activation unit.

So-called “smart buttons” are known from the prior art, which can be controlled, for example, via smartphone applications. For example, under the brand names “Smartswitch” and “Switchbot”, products are sold which can be installed on existing switches or buttons and can be controlled via Bluetooth using a smartphone application in order to operate the switches or buttons. Similar products also offer a WLAN connection. With those products, the original switches do not have to be modified.

Other smart buttons are directly connected to the power grid and replace the original buttons. These smart buttons are also controlled via networks such as WLAN or Bluetooth and can be operated through the Internet.

Devices which allow devices to be operated by means of special input devices are available as a support technology for persons with physical restrictions. Usually, they are coupled with a smart home application, which permits persons with restrictions to interact better with the environment.

Generally, it is considered to be an advantage of smart buttons that their use basically gives a user control over all connected devices and switches. However, this can also be seen as a disadvantage, for example, if guests or business partners are supposed to use the smart buttons as well, since they should not have control over all devices and switches.

Another disadvantage of smart buttons is that they can generally be controlled through the Internet and thus expose the entire connected infrastructure to the outside world, which raises safety concerns. Especially for larger companies, it is rather undesirable to make the entire infrastructure visible to the outside world, as they might also be the target of a hacking attack.

One objective of the present invention was to further develop the already known smart buttons in such a way that they can be used in combination with vehicles such as remote-controlled telepresence robots. In an obvious combination, a user could control the vehicle with one application and operate the smart buttons with another application. As a result, however, the above-mentioned disadvantages of smart buttons persist and, moreover, the use of the overall system is extremely complicated for the end user.

There is therefore a need to further develop the remote-controlled actuation of control elements, as is known from the prior art for smart buttons, in order to use them in new applications, on the one hand, and to give them a safer design, on the other hand.

This object is achieved by a system for the spatially limited activation of a control unit, comprising an activation unit designed for activating the control unit after receiving a control signal, and a user unit designed for transmitting the control signal directly or indirectly to the activation unit, the system furthermore comprising a relay unit designed for communicating with the user unit and with the activation unit, wherein the relay unit and/or the user unit are designed for determining, from a signal of the activation unit received from the relay unit and/or from an image recorded by the relay unit, as to whether the relay unit and the activation unit are located within a predetermined spatial area relative to one another, the user unit being designed for transmitting the control signal for activating the control unit to the activation unit only if the relay unit and the activation unit are located within said predetermined spatial area relative to one another.

According to the invention, it is envisaged that the control units or, respectively, the activation units cannot be activated just by anyone, e.g., through the Internet, but there must be an actual spatial relationship of a relay unit of the user to the activation unit and thus to the control unit, even if the user is outside of a building in which the control unit is disposed. The system according to the invention was originally contemplated for a remotely situated business partner who controls a telepresence robot carrying along the relay unit in a business partner's company building. According to the invention, only control units located close to the presence unit can be activated (e.g., doors can be opened). However, in the course of the development of the invention, other intended uses also became apparent, which will be specified in further detail below, so that the invention is not limited to telepresence robots.

In particular, the system according to the invention allows an existing infrastructure to be upgraded in a particularly simple manner, since the activation units can simply be installed in the vicinity of pre-existing control units. Afterwards, the activation units can activate the control units electromechanically (e.g., by means of an extendable finger) or electrically through a wired interface. Alternatively, existing control units can be replaced by those in which the activation units are already integrated. However, the relay units can, in any case, be designed as simply as possible and do not have to include complex mechanical instruments. Thus, pre-existing telepresence robots can, for example, be used as relay units, as they usually already have a communication unit or, respectively, a camera, which, according to the invention, is also compatible with the activation unit.

In the preferred areas of application, the relay unit is designed as a mobile unit, in particular as a smartphone, tablet, laptop or bodycam. As a result, the relay unit can either be carried along or taken along, and it is possible, according to the invention, to determine when the relay unit comes close to the activation unit. In other embodiments, the relay unit can also have a static design, and the activation unit could be movable together with the control unit.

Furthermore, the system according to the invention preferably comprises a controllable vehicle, in particular a telepresence robot, on which the relay unit is carried along. As a result, the relay unit can be moved without requiring a person to carry the relay unit. In this embodiment, it is particularly preferred if the user unit is designed for controlling both the activation unit and the vehicle, preferably via a common user interface of the user unit. On the one hand, the user thus has the option of moving the vehicle independently and, on the other hand, also the option of activating control units in the vicinity of the vehicle. In the example of the telepresence robot, this gives rise to a particularly interactive sensation when controlling the telepresence robot through a building.

In order that the above-mentioned easy upgradeability of an existing infrastructure is achieved, the control unit and the activation unit can be designed as stationary units, and the activation unit is particularly preferably arranged spatially separate from the control unit and is designed for activating the control unit mechanically. As a result, no electrical connection to the control unit is required, whereby the system can be installed particularly easily and without specialist knowledge.

Particularly preferably, the relay unit comprises a camera and is designed for transmitting images recorded by the camera to the user unit by means of a live stream. The live stream allows the user to keep track of the surroundings of the relay unit, and, as a result, it is possible to easily identify, among other things, which control unit can be operated, e.g., when an operable lift button is in the image or, respectively, the live stream.

A first possibility for determining whether the relay unit and the activation unit are located in said predetermined spatial area relative to one another is to have the relay unit establish a communication link to the activation unit. For this purpose, the relay unit and the activation unit each have a short-range transceiver, wherein the relay unit and/or the user unit are designed for inferring from a successful communication setup between the short-range transceivers that the relay unit and the activation unit are located within the predetermined spatial area relative to one another. This involves the advantage that an evaluation of the images of a camera of the relay unit—or the camera itself—can be omitted. “Successful communication setup” can be understood to mean that the communication is carried out with a predetermined minimum reception strength. In addition to classic wireless connections via WLAN or Bluetooth, communication links can also be established via infrared or ultrasound.

Particularly in the above-mentioned embodiment, it is preferred if the relay unit is designed for receiving the control signal from the user unit, transmitting it to the activation unit via the short-range transceiver. In this case, the same transceivers could be used in order to detect as to whether the two components are located within the predetermined area relative to one another and in order to transfer the control signal to the activation unit. Hence, the activation unit does not have to comprise a transceiver which communicates via the Internet or another long-range communication link, whereby the safety of the system is increased.

A second possibility for determining whether the relay unit and the activation unit are located in said predetermined spatial area relative to one another consists in evaluating the image recorded by the relay unit. In this case, the relay unit or the user unit is designed for identifying the activation unit in the image recorded by the relay unit, preferably in the live stream, and for drawing the conclusion that the relay unit and the activation unit are located in said predetermined spatial area relative to one another if the activation unit is visible in the image or, if applicable, in the live stream.

In the above-mentioned embodiment, it is particularly advantageous if the activation unit comprises a machine-readable optical marker, preferably a QR code. In this way, it can easily be determined whether the activation unit is located in the recorded image. In this context, it should be noted that the activation unit may also comprise spatially separate components so that a transceiver of the activation unit is provided, for example, directly on the control unit and the optical marker is installed at a predetermined distance from the control unit, for example, above a lift switch.

In the above-mentioned embodiments, it is preferred if the optical marker or a communication between the short-range transceivers includes a name, a unique identification and/or information about the position or function of the control unit and/or a unique identification, a state of charge, a network address and/or possible switching states of the activation unit and/or a unique identification of the optical marker. As a result, these data in the relay unit or, respectively, the user unit are known, whereby the user can be shown directly which function the operable control unit assumes and where it is located, respectively. When appropriate, for example, if only one unique identification or a name is transmitted or, respectively, displayed by the activation unit, a table can be stored in the relay unit and/or the user unit, in which data linked to this control unit or, respectively, activation unit are stored. If the communication between the activation unit and the relay unit takes place, for example, via radio, the optical marker can display a unique identification of the optical marker. In this case, it is possible to determine, for example, by means of a previously stored database (“marker library”), which marker belongs to a given activation unit.

Furthermore, the user unit is preferably designed for outputting a depiction of the environment of the relay unit, the depiction preferably being images (in particular a live stream) recorded by the relay unit, alternatively a previously stored depiction of the environment, and the user unit is furthermore designed for highlighting the control unit in the depiction if said unit can be activated via the user unit. As a result, the user is able to see, with particular ease, which control unit can be actuated.

In this context, it should be noted that—even if the detection that the relay unit and the activation unit are located in the predetermined area is effected by means of a camera—a radio connection using transceivers should generally be provided between the relay unit and the activation unit in order to transmit the control signal from the user unit to the relay unit and from there to the activation unit. In a special case, however, no radio connection or no other bidirectional connection could exist between the relay unit and the activation unit, for example, if the only communication between the relay unit and the activation unit consists in a picture of the activation unit that is taken by the relay unit in order to identify whether the two units are located in the predetermined area relative to one another, wherein the control signal is sent from the user unit to the activation unit via the Internet, for example.

In a further preferred embodiment, the activation unit, the relay unit and/or the user unit are designed for activating the control unit only if the relay unit located in the predetermined spatial area relative to the control unit has an appropriate user authorization. In this way, different relay units or, respectively, assigned users are enabled to actuate different control units. For example, a permanent employee of a company can operate more control units than a business partner who visits a company building only temporarily.

The control unit can be designed, for example, for opening or locking a door, calling a lift or switching on a light source, wherein the control unit can be designed so as to be operable both via the activation unit and manually. In this way, dual actuation of the control unit is achieved, once via the remote user unit and once for persons situated close to the control unit.

Returning to the special safety features of the system, it may furthermore be provided that the activation unit is controllable only via a short-range communication link and, when appropriate, manually. Notably, the activation unit should not be connected to the Internet in this particular embodiment, which is not mandatory, however. If the activation unit has a short-range transceiver for communication with the relay unit, it can optionally be envisaged that said transceiver is not incorporated into a network which is connected to the Internet via a gateway.

Advantageous and non-limiting embodiments of the invention are explained in further detail below with reference to the drawings.

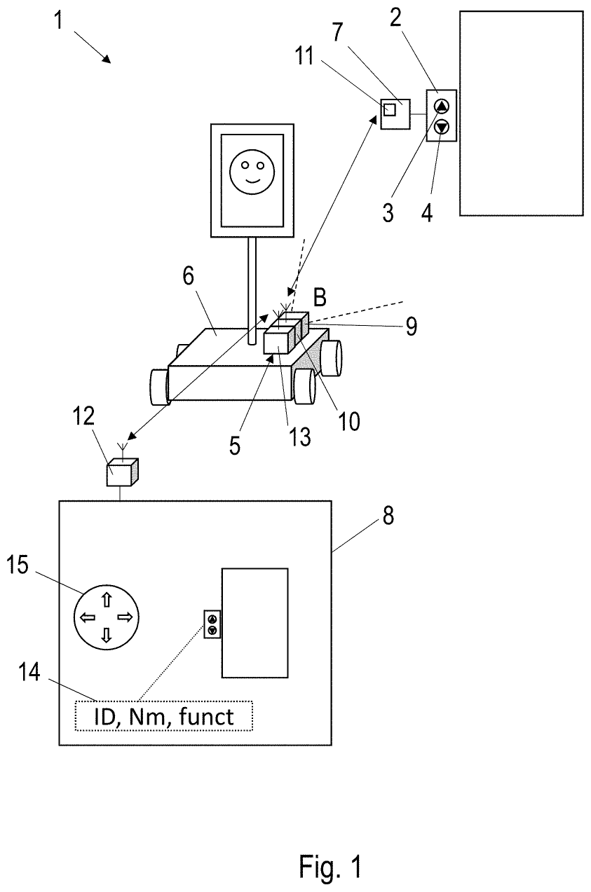

FIG. 1 shows a system for the spatially limited activation of a control unit in a first embodiment with a telepresence robot.

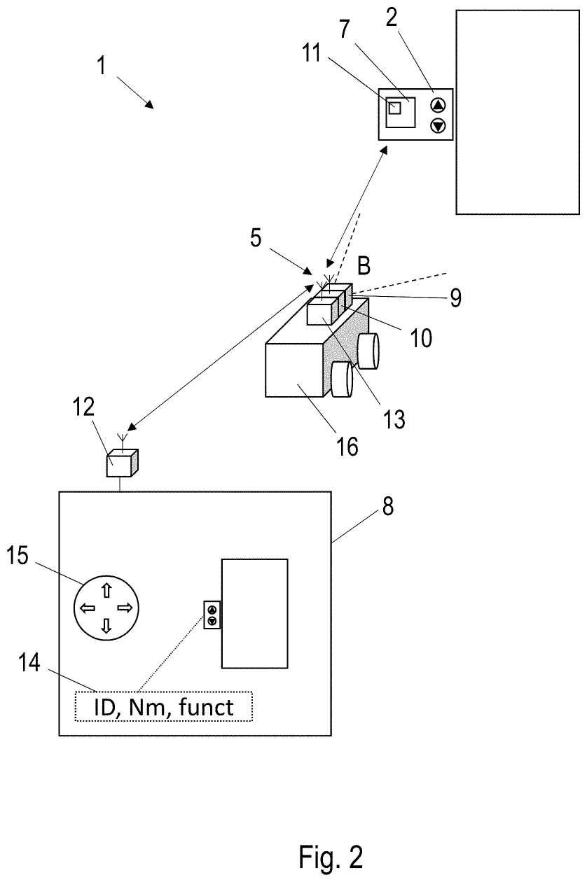

FIG. 2 shows a system for the spatially limited activation of a control unit in a second embodiment with a remote-controlled vehicle.

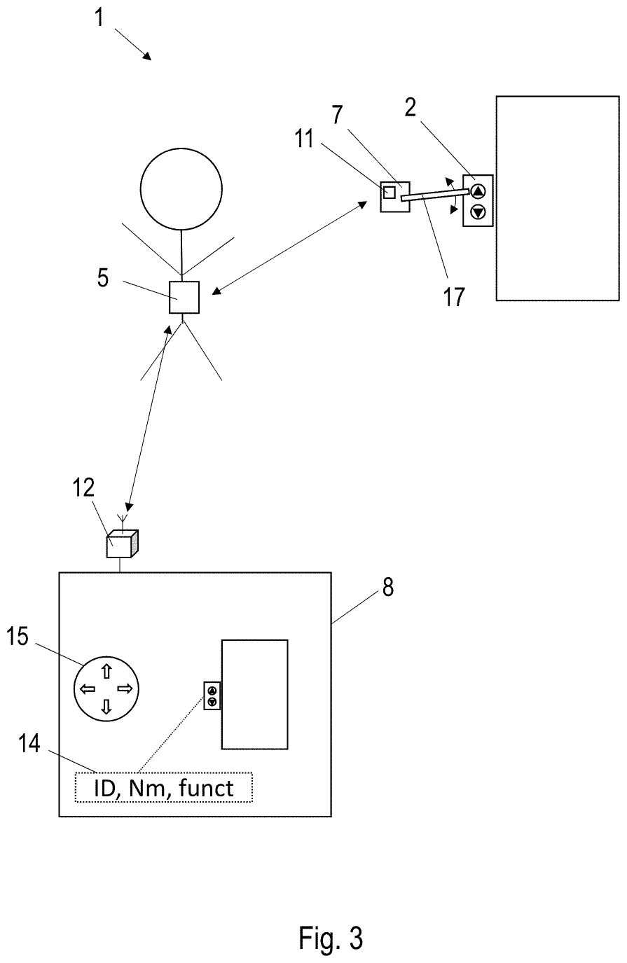

FIG. 3 shows a system for the spatially limited activation of a control unit in a third embodiment with a bodycam.

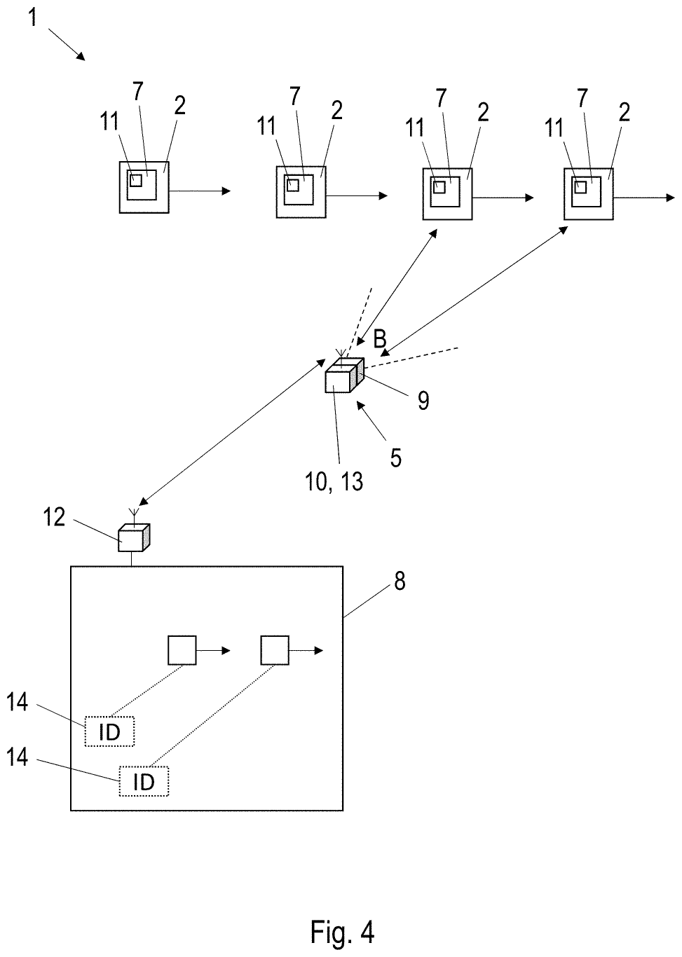

FIG. 4 shows a system for the spatially limited activation of several control units with a static relay unit.

FIG. 1 shows a system 1 for the spatially limited activation of a control unit 2, in this case a lift. In the illustrated example, the control unit 2 has two buttons 3, 4, which each are to be operated by remote control. However, the invention is not limited to this control unit 2, but other control units such as a button for opening, unlocking, closing or locking a door, a light switch or the like could also be used. The system 1 is usually employed in a building in which at least two control units 2 (e.g., two doors or light switches) are provided which can be activated as described below, but the invention is not limited to such intended uses.

In one embodiment, it is the objective of the system 1 that a user can operate the control unit 2 at a remote location, but only if a relay unit 5 is located close to the control unit 2. In a concrete example, the user is a business partner visiting a building by means of a telepresence robot 6 on which the relay unit 5 is mounted. The business partner should always be able to only operate those control units 2 that are located close to the telepresence robot 6. It is thereby achieved that the business partner does not gain access to all control units 2 in the building at the same time, but only to those in the vicinity of the telepresence robot 6, which, on the one hand, gives the user a clearer overview and, on the other hand, increases security.

In order to implement this, the system 1 comprises an activation unit 7 at or near the control unit 2 and a user unit 8 in the vicinity of the user. The user unit 8 can be, for example, a computer with a monitor, such as a smartphone or a laptop. As a rule, two different functions are implemented on the user unit 8, namely firstly the control of the telepresence robot 6 and secondly the activation of the control unit 2. Both functions are preferably implemented in a single application.

The activation unit 7 is located, for example, next to the control unit 2 or can also be designed with this as a single component. The activation unit 7 is usually located at a maximum distance of 3 m, 2 m, 1 m or 0.5 m from the control unit 2. In the example of FIG. 1, the activation unit 7 and the control unit 2 are designed as separate components and are connected electrically, for example, via a connecting cable or else a wireless interface. In the embodiment of FIG. 2, the activation unit 7 and the control unit 2 are designed as a single component and are electrically interconnected. In the embodiment of FIG. 3, the activation unit 7 and the control unit 2 are designed as separate components, wherein the activation unit 7 actuates the control unit 2 mechanically, in this case via a pivotable finger 17, in order to press a switch of the control unit 2. In the illustrated example, the pivotable finger 17 can actuate both buttons selectively, for which it might also be envisaged that the activation unit 7 has one finger 17 each for one of the two buttons, or a separate activation unit 7 with a separate finger 17 for each of the buttons might even be provided.

In general, the activation unit 7 can comprise a mechanical actuator which is designed, for example, for pressing a button of the control unit 2, moving a slider of the control unit 2 and/or turning a rotary knob of the control unit 2. However, it goes without saying that the mechanical actuator is not limited to these embodiments.

Various methods can be applied to determine whether the relay unit 5 and the activation unit 7 are located within a predetermined spatial area relative to one another. In a first example, the relay unit 5 comprises a camera 9 with an image area B. It is to be understood that the telepresence robot 6 and the relay unit 5 can share a single camera 9, in particular if the relay unit 5 is integrated into the telepresence robot 6. As a rule, the images recorded by the camera 9 are sent to the user unit 8 as a live stream so that the user can control the telepresence robot 6 or generally the vehicle on which the relay unit 5 is located. Subsequently, the live stream can be evaluated—usually in the relay unit 5 or in the user unit 8—as to whether the activation unit 7 or the control unit 2 can be identified in the live stream. If this is the case, the relay unit 5 and the activation unit 7 are located in a predetermined spatial area relative to one another. For example, if the relay unit 5 communicates with the activation unit 7 directly via an optical communication link such as an infrared link, the predetermined spatial area does not have to be restricted any further. However, if the relay unit 5 communicates with the activation unit 7, for example, via a radio connection, the predetermined spatial area could be restricted to a specific communication range between these units. Thus, it could also be envisaged that the relay unit 5 and the activation unit 7 are located in the predetermined spatial area relative to one another, if, on the one hand, they are able to establish a communication link and, on the other hand, the activation unit 7 is located in the image area of the relay unit 5.

In order to simplify the determination as to whether the activation unit 7 is in the live stream, the activation unit 7 can, for example, comprise a machine-readable optical marker such as a QR code, which is easily discernible in the live stream. The optical marker can be printed on a plaque or a sticker, for example, and can be provided next to or on the control unit 2. Alternatively or additionally, the activation unit may comprise a display such as an e-paper display on which the optical marker is indicated.

Alternatively or additionally, the relay unit 5 is able to determine by means of a short-range transceiver 10 as to whether the relay unit 5 and the activation unit 7 are located within a predetermined spatial area relative to one another. In this case, the activation unit 7 also includes a corresponding short-range transceiver 11. The two short-range transceivers 10, 11 can communicate with one another, for example, via WLAN, Bluetooth, RFID or another short-range communication standard, possibly also infrared or ultrasound. In this case, the short-range transceiver 10 and/or 11 can permanently check as to whether a communication link can be established with the other respective short-range transceiver 10, 11. If this is the case, the conclusion may be drawn that the relay unit 5 and the activation unit 7 are located within a predetermined spatial area relative to one another. Alternatively, it is possible to draw the conclusion that the relay unit 5 and the activation unit 7 are located within a predetermined spatial area relative to one another only if the strength of the communication link exceeds a predetermined threshold value, which can be determined, for example, via the Received Signal Strength Indicator, RSSI.

The actual determination as to whether the relay unit 5 and the activation unit 7 are located within a predetermined spatial area relative to one another can be made either by the relay unit 5 itself or by the user unit 8. If the determination is made in the relay unit 5, by evaluating either the live stream or the communication link, the relay unit 5 sends a corresponding message to the user unit 8. Alternatively, the relay unit 5 sends the live stream or, respectively, the content of the communication with the short-range transceiver 11 of the activation unit 7, for example, without prior evaluation to the user unit 8, which carries out said determination as to whether the relay unit 5 and the activation unit 7 are located within a predetermined spatial area relative to one another.

The communication between the relay unit 5 and the user unit 8 can take place via said short-range transceiver 10 of the relay unit 5, optionally via the Internet by means of a gateway, which can be located in particular in a WLAN network in which the short-range transceiver 10 communicates. The user unit 8 can comprise its own transceiver 12 for this purpose. However, the relay unit 5 can also comprise a further transceiver 13 which communicates with the transceiver 12 of the user unit 8 directly via a mobile radio network, for example.

As soon as the user unit 8 knows that the relay unit 5 and the activation unit 7 are located within the predetermined spatial area relative to one another, the user unit 8 can give the user the option of activating the control unit 2 by means of the activation unit 7. In one variant, the user unit 8 can show the live stream on an output device such as a monitor, provided that such a device is available, and the control unit 2 can be displayed in the live stream, e.g., as an interactive button 14, preferably at the point where the control unit 2 is located in the live stream. If no live stream is sent from the relay unit 5 or, respectively, the telepresence robot 6 to the user unit 8, a meta view of the building, which was previously stored in the user unit 8, could also be displayed on the output device, for example, and the control unit 2 can be shown in this view as an interactive button 14. In yet other embodiments, a switch area could also simply be displayed on the output device of the user unit 8, and the user is given the opportunity to press the switch area in order to activate the control unit 2. In this context, it should also be mentioned that a switch area 15 for controlling the telepresence robot 6 (or the vehicle in general) can furthermore be output on the output device so that the telepresence robot 6 and the control unit 2 can be controlled via the same user interface or application, respectively.

In the above-mentioned variant, the interactive button 14 is thus displayed on the user unit 8 as soon as the relay unit 5 is located close to the activation unit 7. Alternatively, however, it might also be envisaged that the interactive button 14 is displayed permanently, but actually sends a control signal to the activation unit 7 only when the relay unit 5 and the activation unit 7 are located within said predetermined spatial area relative to one another. In general, it is said that the user unit 8 is designed for sending the control signal to the activation unit 7 for activating the control unit 2 only when the relay unit 5 and the activation unit 7 are located within said predetermined spatial area relative to one another.

In order for the user to receive more information about the control unit 2, the activation unit 7 can send additional information to the relay unit 5 or the user unit 8, respectively. This can be done either via the communication link between the transceivers 10, 11 or via the optical marker such as a QR code, if the latter reproduces the information. The information that can be made available to the user unit 8 is, for example, a name, a unique identification and/or information about the position or function of the control unit 2 and/or a state of charge, a network address and/or possible switching states of the activation unit 7.

If the user unit 8 gives the user the opportunity to activate the control unit 2, i.e., after it has been established that the relay unit 5 and the activation unit 7 are located within a predetermined spatial area relative to one another, and the user takes this opportunity, the user unit 8 sends a corresponding control signal to the activation unit 7.

The control signal can be transmitted to the activation unit 7 via the relay unit 5, i.e., via the transceiver 12 of the user unit 8 to the transceiver 12 of the relay unit 5 (or to the transceiver 10 of the relay unit 5) and subsequently from the transceiver 10 of the relay unit 5 to the transceiver 11 of the activation unit 7. Alternatively or additionally, it may be envisaged that the user unit 8 communicates directly with the activation unit 7, via a mobile radio network, for example. The activation unit 7 can optionally have its own transceiver (not shown) for this purpose.

Referring to FIG. 2, it is evident that the invention is implementable also without a telepresence robot 6. In the illustrated example, the relay unit 5 is provided on a generic vehicle 16 such as, e.g., a cleaning robot. As explained in connection with the embodiment of FIG. 1, a camera 9 can also in this case be provided, which sends a live stream to the user unit 8 in order to control the vehicle 16. All the alternatives and variants explained for the embodiment of FIG. 1 can also be implemented for the embodiment of FIG. 2.

FIG. 3 shows an embodiment in which the relay unit 5 is not arranged on a vehicle but can be carried directly by a person. In one embodiment, the relay unit 5 can, in this case, again comprise a camera 9 and can thus be designed as a bodycam. In a practical implementation, the bodycam can be worn, for example, by security personnel, and the user, e.g., a building manager, at the user unit 8 can specify when which control unit 2 can be opened in the vicinity of the security personnel. The camera 9 can again be used for determining the specified spatial area and/or for transmitting a live stream to the user unit 8, or it can record a video purely for backup purposes and store it in a memory.

In yet another embodiment, the relay unit 5 can also not have a camera 9. This can be used, for example, in connection with a particularly reliable remote diagnosis. For example, only an authorized specialist should have the authorization to activate the control unit 2. If the specialist cannot personally activate the control unit, but is at a remote location, an assistant can bring the relay unit 5 close to the activation unit 7, after which the specialist can activate the control unit 2, for example, in order to record measured values by means of the control unit 2.

In the embodiments of FIGS. 1 to 3, the relay unit 5 is, in each case, designed as a movable unit, and the control units 2 and the associated activation units 7 have a static design. In general, the control units 2 and the associated activation units 7 could also be designed so as to be movable. For example, a monitor could be designed so as to be movable, and the control unit 2 is the monitor's on/off switch. The activation unit 7 could be provided as part of the control unit 2, as described above, or could be mounted beside it. Once the movable monitor is brought close to the relay unit 5 (which could, for example, again be provided on a telepresence robot 6), the user can actuate the control unit 2 on the user unit 8 by the above-described method.

In this context, the relay unit 2 could also have a static design, as illustrated in FIG. 4. One or several control units 2 with activation units 7 can be designed so as to be movable, and it is again possible to detect whether and which control unit 2 is located with its associated activation unit 7 in a predetermined spatial area relative to the relay unit 5. In the illustrated example, the relay unit 5 is, for example, provided statically, e.g., on a passage area, an control units 2 passing through can be activated by remote control via the user unit 8. For example, the control units 2 could be provided on products, and a quality tester at the user unit 8 could use the control units 2 to display a green light when they pass a visual quality check. It is furthermore illustrated that the relay unit 5 can have only one communication device which can communicate both with the user unit 8 and with the activation unit 7, either via the same or via a different communication standard. This can be provided in all embodiments.

Since safety concerns play a major role in all of the aforementioned embodiments, it may furthermore be envisaged that user authorizations are provided for actuating respective control units 2 using the activation units 7. For this purpose, it may be envisaged that the activation unit 7, the relay unit 5 and/or the user unit 8 activate the control unit 2 only if the relay unit 5 located in a predetermined spatial area relative to the control unit 2 has a corresponding user authorization. The reason for this is that, for example, not every business partner should gain access to every control unit 2 in the building. The user authorization can be checked in different ways. For example, appropriate tables and/or keys are stored in the activation unit 7, in the relay unit 5 and/or in the user unit 8. In this case, “user authorization for the relay unit 5” is understood to mean synonymously a user authorization for the user unit 8 and for the user, respectively.

As already explained in detail, the control unit 2 can be activated by the activation unit 7 only if the relay unit 5 and the activation unit 7 are located within a predetermined spatial area relative to one another. As an example of the predetermined spatial area, it has already been stated that, in this area, the activation unit 7 is in the field of view B of the camera 9 of the relay unit 5 and/or that, in this area, a communication link is feasible between the transceivers 10, 11 of the relay unit 5 and the activation unit 7, possibly with a minimum strength of the communication link. It is evident from the above-mentioned examples that the predetermined spatial area is not necessarily defined by a minimum distance, in particular if the activation unit 7 is supposed to be in the field of view B of the camera 9 of the relay unit 5. However, alternatively or in particular additionally, it may be envisaged that the relay unit 5 and the activation unit 7 are to be located at a predetermined minimum distance from each other so that they are located within the predetermined spatial area relative to one another. The minimum distance can be determined, for example, using optical measuring methods, radio waves or GPS data. Particularly preferably, the minimum distance can be determined by a so-called “time-of-flight” method.

As already mentioned, the system 1 can also comprise at least two control units 2, each comprising an activation unit 7. Depending on the arrangement of the control units 2 or, respectively, the activation units 7, it may happen that a relay unit 5 is located within the predetermined spatial area of both control units 2 or, respectively, activation units 7, and the user at the user unit 8 could thereby activate both control units 2. Several relay units 5 may also be present in the system 1, for example, if several telepresence robots 6 are provided, each comprising a relay unit 5. In this case, a separate user unit 8 is usually provided for each relay unit 5.

Another possible application for the present system 1 is the use for persons with physical restrictions. In this case, the relay unit 5 is installed, for example, on a wheelchair constituting the vehicle. The user unit 8 is also provided on this wheelchair so that the person in the wheelchair can operate a control unit 2 as soon as he or she is close to the control unit. This has the advantage of providing a clearer overview, since only those control devices 2 that are in the user's vicinity are displayed to him or her or can be activated by him or her. In addition, the increased safety factor of the system 1 continues to exist, since the activation units 7 cannot be controlled from outside of the building.

1.-15. (canceled)

16. A system for the spatially limited activation of a control unit, comprising an activation unit which is operable to activate the control unit after receiving a control signal, and a user unit operable to transmit the control signal directly or indirectly to the activation unit, wherein the system further comprises a relay unit operable to communicate with the user unit and with the activation unit, wherein the relay unit and/or the user unit are operable to determine, from a signal of the activation unit received from the relay unit and/or from an image recorded by the relay unit, as to whether the relay unit and the activation unit are located within a predetermined spatial area relative to one another, the user unit being operable to transmit the control signal to activate the control unit to the activation unit only if the relay unit and the activation unit are located within said predetermined spatial area relative to one another.

17. A system according to claim 16, wherein the relay unit comprises a portable unit, and the portable unit comprises one of: a smartphone; tablet; laptop computer; or bodycam.

18. A system according to claim 17, further comprising a telepresence robot, on which the relay unit is carried along.

19. A system according to claim 18, wherein the user unit is operable to control both the activation unit and the vehicle, via a common user interface of the user unit.

20. A system according to claim 16, wherein the control unit and the activation unit comprise respective stationary units, and the activation unit is arranged spatially separate from the control unit and is operable to activate the control unit mechanically.

21. A system according to claim 16, wherein the relay unit and the activation unit each have a short-range transceiver, wherein the relay unit and/or the user unit operable to infer, from a successful communication setup between the short-range transceivers, that the relay unit and the activation unit are located within the predetermined spatial area relative to one another.

22. A system according to claim 16, wherein the relay unit and the activation unit each have a short-range transceiver and the relay unit is operable to receive the control signal from the user unit, transmitting the control signal to the activation unit via the short-range transceiver.

23. A system according to claim 16, wherein the relay unit comprises a camera and is operable to transmit images recorded by the camera to the user unit by way of a live stream.

24. A system according to claim 16, wherein the relay unit or the user unit is operable to identify the activation unit in the image recorded by the relay unit, in the live stream, and to conclude that the relay unit and the activation unit are located in said predetermined spatial area relative to one another if the activation unit is visible in the image or, if applicable, in the live stream.

25. A system according to claim 16, wherein the activation unit comprises a machine-readable optical marker.

26. A system according to claim 23, wherein the optical marker or a communication between the short-range transceivers includes a name, a unique identification and/or information about the position or function of the control unit and/or a unique identification, a state of charge, a network address and/or possible switching states of the activation unit and/or a unique identification of the optical marker.

27. A system according to claim 16, wherein the user unit is operable to output a depiction of the environment of the relay unit, the depiction comprising images recorded by the relay unit, and the user unit is further operable to highlight the control unit in the depiction if said unit can be activated via the user unit.

28. A system according to claim 16, wherein the activation unit, the relay unit and/or the user unit are operable to activate the control unit only if the relay unit located in the predetermined spatial area relative to the control unit has an appropriate user authorization.

29. A system according to claim 16, wherein the system further comprises the control unit which is top open or lock a door, call a lift or switch on a light source, wherein the control unit is operable both via the activation unit and manually.

30. A system according to claim 16, wherein the activation unit is controllable only via a short-range communication link and, when appropriate, manually.
